(19) United States
(12) Patent Application Publication
(10) Pub. No.: US 2010/0165838 A1
(43) Pub. Date: Jul. 1, 2010

(54) METHOD AND APPARATUS FOR IMPROVING DATA THROUGHPUT IN A NETWORK

(76) Inventors: Yury Bakshi, Morganville, NJ (US); Carolyn Roche Johnson, Holmdel, NJ (US); Xiaowen Mang, Morganville, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/346,460

(22) Filed: Dec. 30, 2008

(51) Int. Cl. H04L 12/24

(52) U.S. Cl. 370/229

(57) ABSTRACT

A method and apparatus for improving data throughput in a network are disclosed. For example, the method receives at least one packet from a first device, and generates an acknowledgement message for verifying a receipt of the at least one packet, wherein the acknowledgement message comprises a precedence value that indicates that the acknowledgement message is to be handled with a priority in accordance with the precedence value. The method sends the acknowledgement message to the first device.

The present invention relates generally to communication networks and, more particularly, to a method and apparatus for improving data throughput in a network, e.g., Internet Protocol (IP) network, Voice over Internet Protocol (VoIP) network, and the like.

### BACKGROUND OF THE INVENTION

Most of today's communication among businesses and consumers occurs over a network, e.g., the Internet. For example, packets for voice and data services may be transmitted and received over a packet network. The entities sending and receiving the voice and/or data packets rely on a dependable packet transport. As such, most data packets are transported using a packet transport protocol that includes a mechanism for verifying packet delivery. For example, the packet transport protocol may utilize an acknowledgement from a receiver for verifying packet delivery. That is, the packet network may carry a mix of acknowledgement packets, and data and/or voice packets. However, from time to time, the packet network may experience only a unidirectional congestion that causes the loss or delay of acknowledgement packets. Unfortunately, the loss or delay of acknowledgement packets due to the unidirectional congestion may result in propagating the network congestion problem to the opposite direction.

### SUMMARY OF THE INVENTION

In one embodiment, the present invention discloses a method and apparatus for improving data throughput in a network. For example, the method receives at least one packet from a first device, and generates an acknowledgement message for verifying a receipt of the at least one packet, wherein the acknowledgement message comprises a precedence value that indicates that the acknowledgement message is to be handled with a priority in accordance with the precedence value. The method sends the acknowledgement message to the first device.

### BRIEF DESCRIPTION OF THE DRAWINGS

The teaching of the present invention can be readily understood by considering the following detailed description in conjunction with the accompanying drawings, in which:

FIG. 1 illustrates an exemplary network in accordance with one embodiment of the present invention for improving data throughput in a network;

FIG. 2 illustrates a flowchart of a method for improving data throughput in accordance with one embodiment of the present invention; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for improving data throughput in a network such as an Internet Protocol (IP) or Voice over Internet Protocol (VoIP) network. Although the present invention is discussed below in the context of IP networks, the present invention is not so limited. Namely, the present invention can be applied for other networks such as the cellular networks, circuit switched networks, wireless networks, and the like.

Packets for voice, data, and/or multimedia services (broadly herein referred to as service packets) may be transported using a reliable packet transport protocol, e.g., Transport Control Protocol (TCP), Stream Control Transmission Protocol (SCTP), and the like, that includes a mechanism for verifying service packet delivery. The mechanism for verifying service packet delivery may be sending acknowledgement packets from a device that receives the service packets to a device that transmits the service packets. For example, if the service packet traverses a network from a device X to a device Y, the acknowledgement packets may traverse the network from the device Y back to the device X.

However, from time to time, the packet network may experience only a unidirectional congestion, e.g., from a direction from side A of the network to side B of the network (broadly A-B direction). For example, a number of servers are located on side A of the network that is serving a plurality of clients on side B of the network. Generally, in a server-client relationship, the amount of data transported from a client to a server is often far less than the amount of data transported from the server to the client. Since most of the traffic between the interactions among the servers and the clients embodies the transmission of a significantly greater number of service packets from the servers to the clients, it is possible that the packet network will experience a unidirectional congestion, i.e., from the direction from side A (e.g., where majority of servers is located) of the network to side B of the network (e.g., where majority of clients is located).

However, there may also be servers situated on side B of the network that are serving requests from clients on side A of the network, e.g., from a direction from the side B of the network to the side A of the network (broadly B-A direction). When a client receives some data from a server, it is expected that the client will send an acknowledgement back to the server, which in turn will continue to send more data towards the client.

Unfortunately, the unidirectional congestion as discussed above may cause the acknowledgement to either be lost or delayed in the A-B direction. In turn, the server that originally transmitted the data in the B-A direction may then erroneously assume that the data is lost and needs to be retransmitted. That is, the loss or delay of the acknowledgement packets in the A-B direction may result in retransmission of the service packets in the B-A direction. Furthermore, repetitive retransmission of data may eventually cause the network in the B-A direction to be become congested as well. Hence, the loss or delay of acknowledgement packets due to a unidirectional network congestion may result in propagating the network congestion problem to the opposite direction.

In other words, from time to time, the offered load in one direction may exceed the capacity of a link while the offered load in the opposite direction is operating below the capacity of the link. The result is that packets in the congested direction may then be dropped. If the acknowledgement packets are traversing the network in the congested direction, such acknowledgement packets may be either lost or delayed. Without receiving the expected acknowledgement packets, the device that transmitted service packets may then attempt to retransmit these packets. This recurring retransmission of the service packets may eventually result in congesting the previously uncongested direction of transmission. Effectively, the throughput for the entire network may be reduced due to unnecessary data retransmission. It should be noted that in certain applications voice packets may not be retransmitted.

In one embodiment, the present invention provides a method and apparatus for increasing or improving data throughput in a network. In order to clearly illustrate the teachings of the current invention, the concept of Transport Control Protocol over Internet Protocol (TCP/IP) will first be described.

Transport Control Protocol (TCP) refers to a protocol that operates between an application program and the Internet Protocol (IP) to facilitate sending data in units of data segments instead of units of individual IP packets. An IP network is broadly defined as a network that uses Internet Protocol such as IPv4 or IPv6, and the like, to exchange data packets. The packets sent over an IP network are referred to as IP packets and comprise a header and a body. The header describes the packet's destination and, optionally, the routers to be used for forwarding. The body contains the data that is being transmitted. TCP/IP refers to a data transport protocol in which the IP layer handles the actual delivery of the data, and the TCP layer handles keeping track of the individual units of data segments that a message is divided into for efficient routing through the network.

For example, when the IP is transmitting data on behalf of TCP, the content of the body of the IP packet is a TCP payload. Specifically, when an application program needs to send a large chunk of data across the Internet using IP, instead of breaking the data into IP-sized packets and issuing a series of IP requests, the application program may issue a single request to the TCP layer and rely on the TCP layer to handle the dividing of the data into multiple segments. The IP layer may then turn each segment into an IP packet.

For example, an HTML (HyperText Markup Language) file may be sent to a client computer from a server computer using a HyperText Transfer Protocol (HTTP) over TCP. The TCP layer of the server computer may take the HTML file as a stream of bytes and divide it into segments. The TCP layer in the server computer may also number the segments and forward each segment to the IP layer. The IP layer may then turn each received segment into an IP packet by adding a header which includes a destination IP address and, optionally, the routers to be used for forwarding. The IP packets may then be sent to the destination (i.e., the client computer). The TCP layer in the client computer may receive the IP packets, and reassemble the individual segments while ensuring that the segments are correctly ordered. The TCP layer in the client computer may then stream the reassembled segments to output the HTML file.

The TCP layer also employs a mechanism to verify the delivery of a data stream via a positive acknowledgement from a receiver of the data stream. For example, IP packets may be lost due to network problems, e.g., congestion, network failure, network degradation, etc. If the lost IP packets are transmitting data on behalf of TCP, then the TCP layer will be able to detect the loss of the IP packets by detecting the absence of the acknowledgement packets. The TCP layer then requests the retransmission of the lost packets. Specifically, the transmitting device sending the data packets will keep a record of the data packets that have been sent, and will wait for the acknowledgments from the receiving device that it has received the data packets. The transmitting device will also operate a timer, and will retransmit the data packets if the timer expires without receiving a positive acknowledgment from the intended receiving device.

In one embodiment, the IP layer may assign an IP precedence value to each packet. For example, the IP precedence value may range from zero to seven. Packets with an IP precedence value of zero would receive the lowest priority, whereas packets with an IP precedence value of seven would receive the highest priority. For example, the assignment of the IP precedence value can be performed by the device sending the data/voice/multimedia packets.

It should be noted that although the above illustrative example is described in the context of TCP/IP, the present invention is not so limited. In other words, the present invention can be adapted to any communication protocol that employs acknowledgement messages as a delivery verification mechanism.

As described earlier, the packets associated with an acknowledgment message may be either lost or delayed due to the unidirectional congestion affecting packets traversing the network in the same direction as the acknowledgement packets. The loss or delay of the acknowledgement packets may then cause repetitive retransmission of the service packets in the opposite direction, which in turn may reduce the throughput for the entire network.

In one embodiment, the present invention provides a method and apparatus for increasing or improving data throughput in a network. For example, the method provides an Acknowledgement Priority Resetting Scheme (APRS). The APRS enables an acknowledgement packet to be given a higher precedence value, e.g., a higher IP precedence value.

In one embodiment, the method receives one or more packets (e.g., data, and/or multimedia). For example, a receiving device, e.g., a client computer, may receive one or more service packets from a server. The method then generates an acknowledgement packet for validating the receipt of the one or more service packets. For the example above, the client computer that received the one or more service packets from the server computer may generate an acknowledgment packet. For example, if Transport Control Protocol (TCP) is being used between the application layer and the IP layer, the TCP layer in the client computer may generate the acknowledgement packet by setting the ACK flag bit in the TCP header.

In one embodiment, the present method then determines if an Acknowledgement Priority Resetting Scheme (APRS) is to be performed for the acknowledgement packet. If an APRS is to be performed, the method then proceeds to generate an acknowledgment packet with the higher IP precedence value, as described below. However, if an APRS is not to be performed, the method may then send the acknowledgment packet towards its destination without setting a higher IP precedence value for the acknowledgment packet.

In one embodiment, the present method may provide an APRS for used with all protocols that employ an acknowledgement verification mechanism. For example, TCP, Stream Control Transmission Protocol (SCTP), Datagram Congestion Control Protocol (DCCP), and the like have a mechanism for verifying packet delivery. The network service provider may then enable the APRS for all/some protocols that have a mechanism for verifying packet delivery.

In one embodiment, the method provides an APRS based on a type of session. For example, the method may provide an APRS for data sessions. In another example, the method may provide an APRS for multicast sessions.

In one embodiment, the method provides an APRS based on a quality of service. For example, the method may determine if the packet is associated with a premium service. The acknowledgment packet associated with the premium service may then be provided with an APRS such that it is assigned a higher IP precedence value than other acknowledgment packets not associated with a premium service.

In one embodiment, the method provides an APRS based on a particular port. For example, acknowledgement packets for data received from a specific predetermined port may be provided with an APRS. For example, the port may have been assigned for receiving critical traffic.

In one embodiment, the method provides an APRS based on a type of application. For example, acknowledgement packets for HTML files that use HTTP in the application layer may be provided with an APRS.

In one embodiment, the method provides an APRS for a predetermined percentage of packets. For example, 50% of acknowledgement packets may be provided with an APRS.

In one embodiment, the present method may generate an acknowledgement packet with a modified IP precedence value when compared with the IP precedence value that was assigned to a received packet. For example, a receiving device may receive a packet having a predefined IP precedence value associated with the received packet. However, in response to the received packet, the receiving device may provide a modified IP precedence value that is different (e.g., having a greater value), than the predefined IP precedence value associated with the received packet. For example, the IP layer may examine the received packet to determine that the received packet has an IP precedence value of “zero”. In response, the IP layer then assigns an IP precedence value of “two” (broadly referred to as a modified IP precedence value) in an acknowledgement packet, such that the acknowledgement packet will be treated with a greater priority when compared to the received packet. The method may then send the acknowledgement packet with the modified IP precedence value back to the sending device.

In one embodiment, applying the APRS on the acknowledgement packet comprises, assigning the acknowledgement packet with a predetermined IP precedence value. For example, the service provider may preselect high IP precedence value to be assigned to the acknowledgement packet, if usage of the APRS is applicable. For example, the method may assign the acknowledgement packet an IP precedence value of “five” and so on.

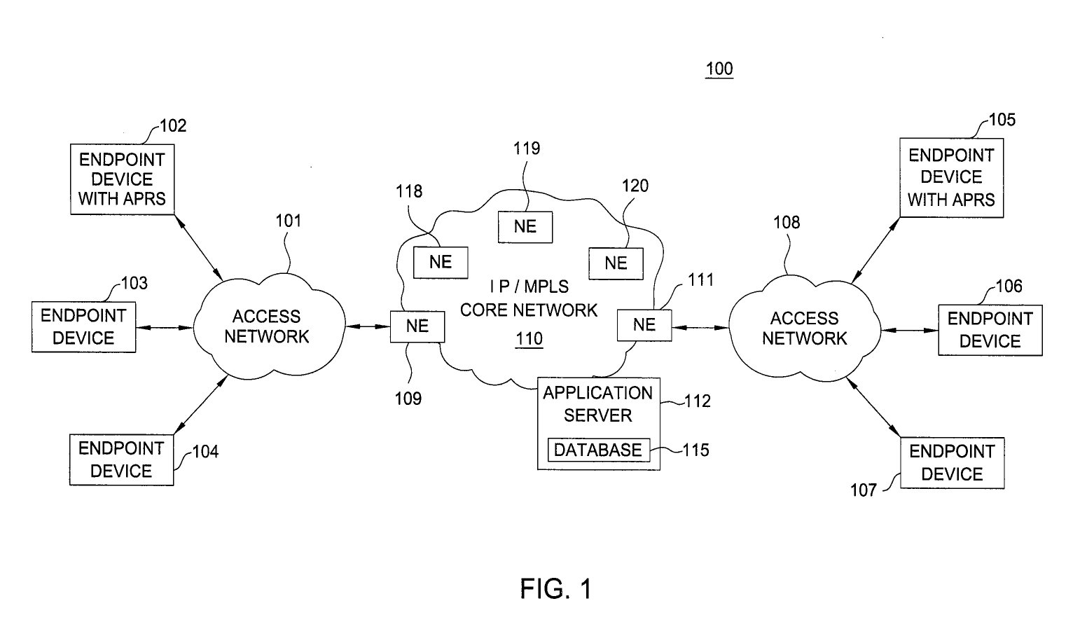

FIG. 1 illustrates an exemplary network 100 for improving or increasing data throughput in a network in accordance with one embodiment of the current invention. For example, the exemplary networks may include Internet protocol (IP) networks, Ethernet networks, and the like. In one embodiment, the network 100 may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

In one embodiment, the endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the Network Elements (NEs) 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art.

In one embodiment, the service provider may implement an acknowledgement priority resetting scheme in endpoint devices 102 and 105. That is, endpoint devices 102 and 105 are configured to allow the assignment of a precedence value to the acknowledgment messages or packets in accordance with criteria set by the network service provider (or by a customer, or by a third party operator of the endpoint device, e.g., an operator of a server hosting a particular application or website). Namely, the precedence value indicates that the acknowledgement message or packet is to be handled with a priority in accordance with the precedence value. In one example, the criteria may enable applying an APRS for all acknowledgment packets. In another example, the criteria may enable applying an APRS to only certain applications or communication protocols, e.g., TCP applications, and so on.

In one embodiment, the endpoint device 102 (e.g., acting as a server) sends requested packets to the endpoint device 105 (e.g., acting as a client) via the access network 101, the IP/MPLS core network 110, and the access network 108. For example, the data packets may be sent to the endpoint device 105 in multiple segments using a TCP/IP protocol. The data, voice and/or multimedia packets may traverse the network 110 from NE 109 to NE 111. The endpoint device 105 may then send an acknowledgment packet to the endpoint device 102 after receiving each segment of the data. That is, the acknowledgement packet traverses the access network 108, the IP/MPLS core network 110, and the access network 101. The acknowledgement packet may be assigned a precedence value, e.g., a higher IP precedence value, by the IP layer in the endpoint device 105. Assigning a higher IP precedence value to the acknowledgment packet may prevent the acknowledgment packet from being dropped due to potential congestions that may exist in the IP/MPLS network 110 or the access networks 101 and 108.

The endpoint device 102 may then receive the acknowledgement packet and proceed to sending the next segment, until the entire data (all segments) is sent. Thus, the successful delivery of the acknowledgment packets along the congested network path from the client 105 to the server 102 will prevent throughput reduction along the reverse uncongested network path (from the server 102 to the client 105). For example, the number of retransmitted packets will be reduced since the acknowledgement packets are given priority.

It should be noted that although only six endpoint devices, two access networks, five network elements and so on are depicted in FIG. 1, the communication system 100 may be expanded by including additional endpoint devices, access networks, network elements, and/or application servers, without altering the scope of the present invention.

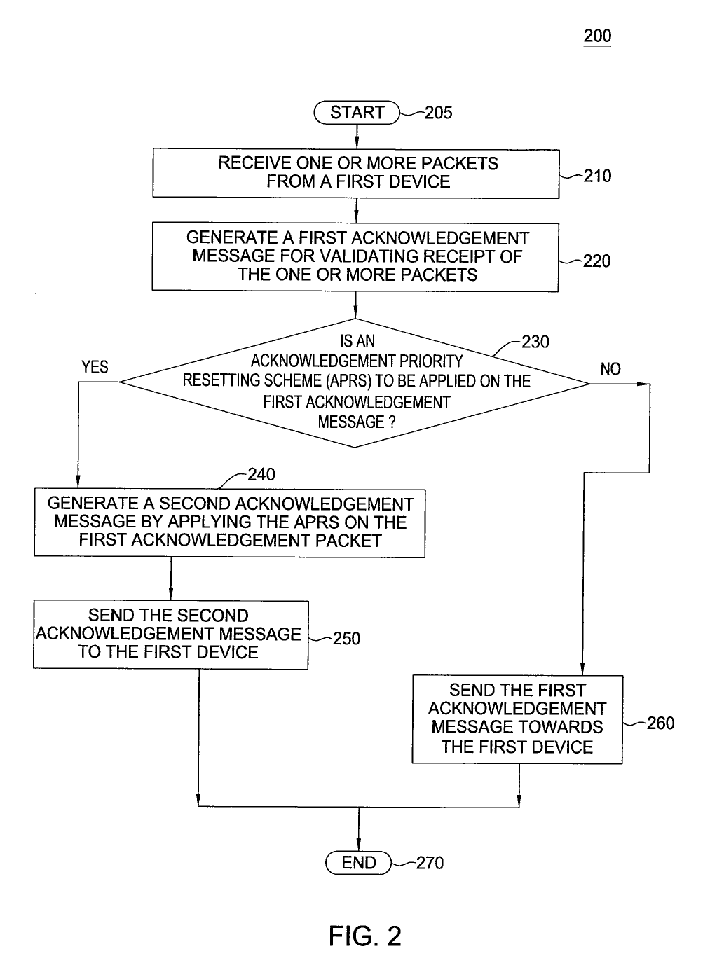

FIG. 2 illustrates a flowchart of a method 200 for increasing data throughput in a network. For example, one or more steps of step 200 may be implemented in an endpoint device. Method 200 starts in step 205 and proceeds to step 210.

In step 210, method 200 receives a service packet (broadly encompassing one or more packets of data, voice, and/or multimedia information) from a first device. For example, a receiving endpoint device, e.g., a client computer, may receive one or more packets from a server. Thus, the first device is the server sending the one or more packets.

In step 220, method 200 generates a first acknowledgement message (broadly encompassing one or more acknowledgement packets) for validating or verifying receipt of the one or more packets. For example, if the packets are being transmitted using TCP/IP, the TCP layer in the client computer may generate the acknowledgement message or packet by setting the ACK flag bit in the TCP header. The acknowledgement message or packet is generated by the TCP layer to serve as a means of validating or verifying the receipt of the one or more packets.

In step 230, method 200 determines if an Acknowledgement Priority Resetting Scheme (APRS) is to be applied on the first acknowledgement message or packet. If an APRS is to be applied, the method then proceeds to step 240. Otherwise, the method proceeds to step 260.

In step 240, method 200 generates a second acknowledgement message or packet by applying the APRS on the first acknowledgement message or packet. For example, the IP layer may generate a second acknowledgement message or packet by assigning a higher IP precedence value than originally set for the first acknowledgement message. For example, if no precedence value was originally set for the first acknowledgement message, then a precedence value will be set for second acknowledgement message or packet. In another example, if the APRS assigns a predetermined precedence value (e.g., a value of 5) to all acknowledgement packets (irrespective of whether a precedence value was initially detected in the received packet or set in the first acknowledgement message), then the IP layer may assign the predetermined precedence value regardless of the precedence value of the received packet.

In step 250, method 200 sends the second acknowledgement message or packet to the first device. For example, the method may send the acknowledgment message or packet to the device that sent the received packets. The second acknowledgment packet may contain a higher IP precedence value as compared to the IP precedence value of the received packets. That is, an APRS is applied to the acknowledgment message or packet so that it can be treated by the network as higher priority traffic. The method then ends in step 270.

In step 260, method 200 simply sends the first acknowledgement message or packet towards the first device. For example, the method may not assign any precedence level to the acknowledgement message or packet that is sent back towards the first device. In another example, the method may assign an IP precedence value to the first acknowledgement message or packet identical to the IP precedence value of the received packet and then sends the acknowledgement message or packet back to the first device. That is, the method does not apply the APRS. The method then ends in step 270.

It should be noted that although the above method 200 describes the generation of a second acknowledgement message or packet, the present invention is not so limited. In other words, the method may simply modify the first acknowledgement message or packet with the pertinent precedence value, or alternatively, the method may simply generate the first acknowledgement message or packet with the precedence value, if APRS is determined at the beginning of method 200.

It should be noted that although not specifically specified, one or more steps of method 200 may include a storing, displaying and/or outputting step as required for a particular application. In other words, any data, records, fields, and/or intermediate results discussed in the method 200 can be stored, displayed and/or outputted to another device as required for a particular application. Furthermore, steps or blocks in FIG. 2 that recite a determining operation, or involve a decision, do not necessarily require that both branches of the determining operation be practiced. In other words, one of the branches of the determining operation can be deemed as an optional step

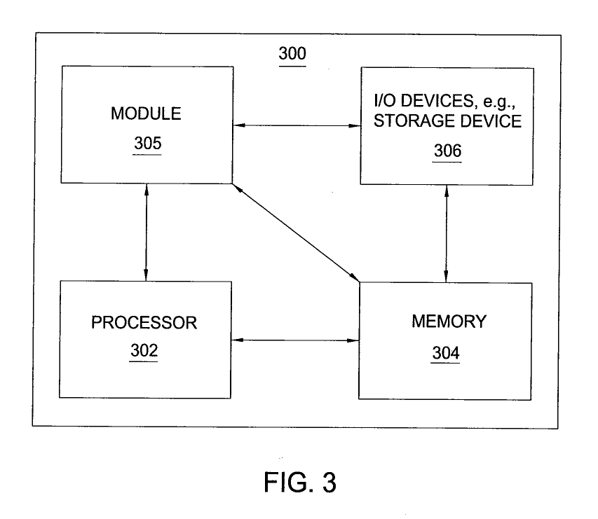

FIG. 3 depicts a high-level block diagram of a general-purpose computer suitable for use in performing the functions described herein. As depicted in FIG. 3, the system 300 comprises a processor element 302 (e.g., a CPU), a memory 304, e.g., random access memory (RAM) and/or read only memory (ROM), a module 305 for improving data throughput in a network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module for improving data throughput in a network or process 305 can be loaded into memory 304 and executed by processor 302 to implement the functions as discussed above. As such, the present method 305 for improving data throughput in a network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for sending an acknowledgment message in a network, comprising:
receiving at least one packet from a first device;
generating an acknowledgement message for verifying a receipt of said at least one packet, wherein said acknowledgement message comprises a precedence value that indicates that said acknowledgement message is to be handled with a priority in accordance with said precedence value; and
sending said acknowledgement message to said first device.

2. The method of claim 1, wherein said precedence value is set to a higher priority than a priority that was associated with said at least one packet.

3. The method of claim 1, wherein said precedence value is set in accordance with whether an Acknowledgement Priority Resetting Scheme (APRS) is to be applied to said acknowledgement message.

4. The method of claim 3, wherein said APRS is applied to said acknowledgement message, if said at least one packet is received using a protocol that has a mechanism of verifying packet delivery.

5. The method of claim 4, wherein said protocol comprises at least one of: a Transport Control Protocol (TCP), a Stream Control Transmission Protocol (SCTP), or a Datagram Congestion Control Protocol (DCCP).

6. The method of claim 3, wherein said APRS is applied to said acknowledgement message based on at least one of: a type of session, a quality of service, a port, a type of application, or a predetermined percentage of packets.

7. The method of claim 1, wherein said generating said acknowledgement message comprises modifying a first acknowledgement with said precedence value.

8. The method of claim 1, wherein said generating said acknowledgement message comprises generating a second acknowledgement message with said precedence value, wherein said precedence value of said second acknowledgement message is different from a precedence value of a first acknowledgement message.

9. The method of claim 8, wherein said precedence value of said second acknowledgement message has a higher precedence value as compared to said precedence value of said first acknowledgement message.

10. A computer-readable medium having stored thereon a plurality of instructions, the plurality of instructions including instructions which, when executed by a processor, cause the processor to perform steps of a method for sending an acknowledgment message in a network, comprising:
receiving at least one packet from a first device;
generating an acknowledgement message for verifying a receipt of said at least one packet, wherein said acknowledgement message comprises a precedence value that indicates that said acknowledgement message is to be handled with a priority in accordance with said precedence value; and
sending said acknowledgement message to said first device.

11. The computer-readable medium of claim 10, wherein said precedence value is set to a higher priority than a priority that was associated with said at least one packet.

12. The computer-readable medium of claim 10, wherein said precedence value is set in accordance with whether an Acknowledgement Priority Resetting Scheme (APRS) is to be applied to said acknowledgement message.

13. The computer-readable medium of claim 12, wherein said APRS is applied to said acknowledgement message, if said at least one packet is received using a protocol that has a mechanism of verifying packet delivery.

14. The computer-readable medium of claim 13, wherein said protocol comprises at least one of: a Transport Control Protocol (TCP), a Stream Control Transmission Protocol (SCTP), or a Datagram Congestion Control Protocol (DCCP).

15. The computer-readable medium of claim 12, wherein said APRS is applied to said acknowledgement message based on at least one of: a type of session, a quality of service, a port, a type of application, or a predetermined percentage of packets.

16. The computer-readable medium of claim 10, wherein said generating said acknowledgement message comprises modifying a first acknowledgement with said precedence value.

17. The computer-readable medium of claim 10, wherein said generating said acknowledgement message comprises generating a second acknowledgement message with said precedence value, wherein said precedence value of said second acknowledgement message is different from a precedence value of a first acknowledgement message.

18. The computer-readable medium of claim 17, wherein said precedence value of said second acknowledgement message has a higher precedence value as compared to said precedence value of said first acknowledgement message.

19. An apparatus for sending an acknowledgment message in a network, comprising:
means for receiving at least one packet from a first device;
means for generating an acknowledgement message for verifying a receipt of said at least one packet, wherein said acknowledgement message comprises a precedence value that indicates that said acknowledgement message is to be handled with a priority in accordance with said precedence value; and
means for sending said acknowledgement message to said first device.

20. The apparatus of claim 19, wherein said precedence value is set to a higher priority than a priority that was associated with said at least one packet.
